(19) United States
(12) Patent Application Publication
(10) Pub. No.: US 2025/0100636 A1
(43) Pub. Date: Mar. 27, 2025

(54) MOUNTING FIXTURE FOR A MASTER CYLINDER ASSEMBLY OF A VEHICLE BRAKING SYSTEM

(71) Applicant: Toyota Motor Engineering & Manufacturing North America, Inc., Plano, TX (US)

(72) Inventors: Williams Lopez, Waterloo (CA); Dorin Turlea, Cambridge (CA)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/473,495

(22) Filed: Sep. 25, 2023

(51) Int. Cl. B62D 65/02; B23Q 1/03

(52) U.S. Cl. CPC B62D 65/026; B23Q 1/03

(57) ABSTRACT

A mounting fixture for holding a braking system master cylinder against a mounting element in a vehicle engine compartment includes a base and an anchor portion secured to the base and structured to secure a portion of the mounting fixture to a wheel well in the engine compartment. A cylinder assembly engagement member is secured to the base opposite the anchor portion. In some arrangements, the mounting element may be a firewall of the engine compartment. Use of the fixture to hold the cylinder in position with respect to the mounting element enables a user to operatively connect a brake pedal to the cylinder without the need to manually secure the cylinder in position during connection.

### TECHNICAL FIELD

The present invention relates to mounting fixtures and, more particularly, to a mounting fixture for holding a master cylinder assembly of a vehicle braking system in position in a vehicle engine compartment, to enable connection of a brake pedal to the cylinder assembly.

### BACKGROUND

During vehicle assembly, a braking system master cylinder assembly is operatively connected a vehicle brake pedal. To connect the master cylinder assembly to the brake pedal, the cylinder assembly may need to be held in a predetermined position within the vehicle engine compartment while the connection is made manually. However, the engine compartment is crowded with other vehicle components. Thus, it may be difficult to position the cylinder assembly and to apply a mechanism for securing the assembly in position for attachment to the brake pedal. Depending on the positional securement method used, it may also be difficult to manually connect the cylinder assembly to the brake pedal without moving the assembly out of its desired attachment position.

### SUMMARY

In one aspect of the embodiments described herein, a mounting fixture is provided for holding a braking system master cylinder assembly against a mounting element in a vehicle engine compartment. The fixture includes a base and an anchor portion secured to the base and structured to secure a portion of the mounting fixture to a wheel well in the engine compartment. A cylinder assembly engagement member is secured to the base opposite the anchor portion. When the base and the anchor portion are mounted so as to be fixed within the engine compartment, the engagement member contacts the cylinder assembly to reliably and firmly hold it against a firewall in the engine compartment so that the cylinder assembly can be operatively connected to a brake pedal.

### BRIEF DESCRIPTION OF THE DRAWINGS

The accompanying drawings, which are incorporated in and constitute a part of the specification, illustrate various systems, methods, and other embodiments of the disclosure. In some embodiments, one element may be designed as multiple elements or multiple elements may be designed as one element. In some embodiments, an element shown as an internal component of another element may be implemented as an external component and vice versa. Furthermore, elements may not be drawn to scale. Also, unless otherwise stated or shown, the same or similar elements shown in different views may be given the same or similar reference numerals or designations.

FIG. 1 is a schematic perspective view of an engine compartment of a vehicle.

FIG. 2 is a schematic perspective view of a mounting fixture in accordance with an embodiment described herein.

FIG. 3 is a schematic plan view of the mounting fixture of FIG. 2 with the addition of a spacer mounted along a side of a master cylinder assembly engagement member of the fixture.

FIG. 4A is a schematic side cross-sectional view illustrating the process of engaging an anchor portion of the mounting fixture with a wheel well in the engine compartment.

FIG. 4B is the view of FIG. 4A showing the anchor portion of the mounting fixture fully engaged with the wheel well, with the anchor portion secured to the wheel well.

FIG. 4C is a schematic perspective view of an underside or second side S2 of the wheel well showing the cylindrical edge portion 38e in contact with the edge 24a of the opening 24 and the securement portion 40 bearing against a depression 22d formed in the wheel well 22

FIG. 5 is a schematic perspective view of the fixture of FIGS. 2 and 3 mounted in the vehicle engine compartment and bracing the master cylinder assembly against a firewall.

### DETAILED DESCRIPTION

A mounting fixture is structured for holding a braking system master cylinder assembly against a mounting element in a vehicle engine compartment. The fixture includes a base and an anchor portion secured to the base and structured to secure an end of the mounting fixture to a wheel well in the engine compartment. A cylinder assembly engagement member is secured to the base opposite the anchor portion for contacting the cylinder and holding the cylinder in contact with the mounting element. In some arrangements, the mounting element may be a firewall of the engine compartment. Use of the fixture to hold the cylinder in position with respect to the mounting element enables a user to operatively connect a brake pedal to the cylinder without the need to manually secure the cylinder in position during connection.

In the following description, the upper and lower directions and relative positions indicate upper and lower directions and positions from the perspective of a user standing adjacent the vehicle and looking down into the engine compartment.

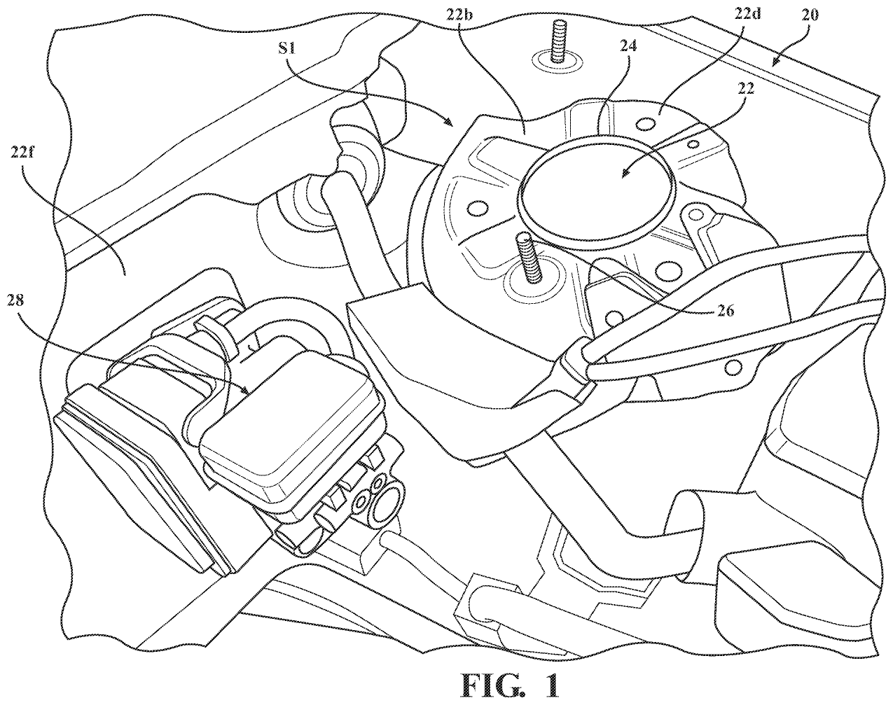

FIG. 1 is a schematic perspective view of an engine compartment (generally designated 20) of a vehicle. The engine compartment 20 may be an engine compartment of a hybrid electric vehicle. However, one or more embodiments of the fixture described herein may be used on other types of vehicles.

A wheel well 22 may be mounted in the engine compartment 20. The wheel well 22 may have an opening 24 formed therein. The opening 24 may extend (and enable communication between) a first or upper side S1 of the wheel well and a second or lower side S2 of the wheel well residing opposite the first side S1. A stud 26 may project upwardly from a body 22b of the wheel well 22 at a location between the wheel well opening 24 and an attachment location of the master cylinder assembly in the engine compartment. In some arrangements, depressions 22d may be formed in the body 22b of the wheel well 22 for purposes of strengthening the body.

A bulkhead or firewall 20f may separate the engine compartment 20 from a passenger compartment (not shown) of the vehicle. During vehicle assembly, a braking system master cylinder assembly (generally designated 28) may be installed in the engine compartment 20. During installation of the master cylinder assembly 28, it may be necessary to secure the cylinder assembly in a predetermined position so that the cylinder assembly 28 may be operatively connected to a brake pedal (not shown) of the vehicle. For example, in some cases, the master cylinder assembly 28 may be held or braced against a mounting element (such as firewall 20f) in the engine compartment 20 while the brake pedal is connected to the cylinder assembly 28.

Because the engine compartment 20 is crowded with other vehicle components, it may be difficult to maintain the master cylinder assembly 28 in its desired position during connection to the brake pedal. When properly mounted in the engine compartment 20, embodiments of the fixture described herein operate to brace the master cylinder assembly 28 against a mounting element (such as firewall 20f), to hold the master cylinder assembly 28 in position for connection to the brake pedal.

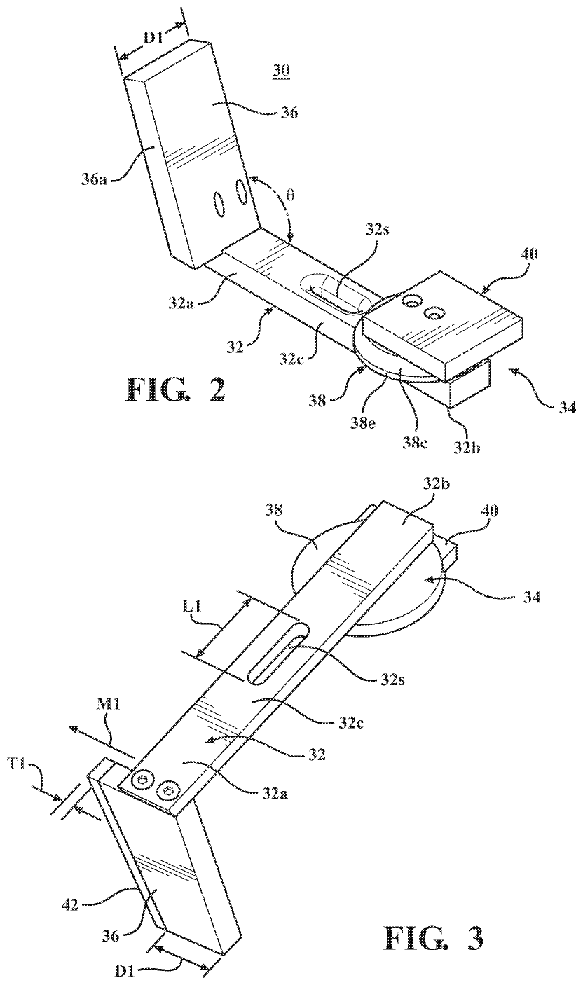

FIG. 2 is a schematic perspective view of a mounting fixture (generally designated 30) in accordance with an embodiment described herein. The mounting fixture 30 may be structured for holding the braking system master cylinder assembly 28 against a mounting element in the vehicle engine compartment 20 so that the cylinder assembly 28 may be operatively connected to a brake pedal of the vehicle. In particular arrangements, the mounting element may be a firewall (such as firewall 20f) of the engine compartment 20.

Referring to FIG. 2, the mounting fixture 30 may include a base 32, an anchor portion 34 secured to the base 32, and a cylinder engagement member 36 secured to the base 32 opposite the anchor portion 34. The various elements of the mounting fixture 30 described herein may be formed from any material or materials suitable for the purposes described. The various elements of the mounting fixture 30 may be attached to each other using bolts, adhesives, and/or any other suitable method.

The base 32 may have a first end 32a, a second end 32b opposite the first end, and a body 32c extending between the first and second ends 32a, 32b. A slot 32s may be formed along body 32c. The slot 32s may be structured so as to be positioned between the anchor portion 34 and the cylinder assembly engagement member 36 of the assembled fixture 30. The slot 32s may be structured to receive therein stud 26 extending from wheel well 22, in a close sliding fit. The slot 32s may have a longitudinal dimension L1 selected to enable a degree of positional adjustment of the base 32 with respect to the stud 26 when the stud is received in the slot 32s. For example, the position of the base 32 with respect to the stud 26 may be adjusted by moving the base 32 so that the stud 26 moves along the slot 32s and relative to the slot when the stud 26 is received in the slot 32s.

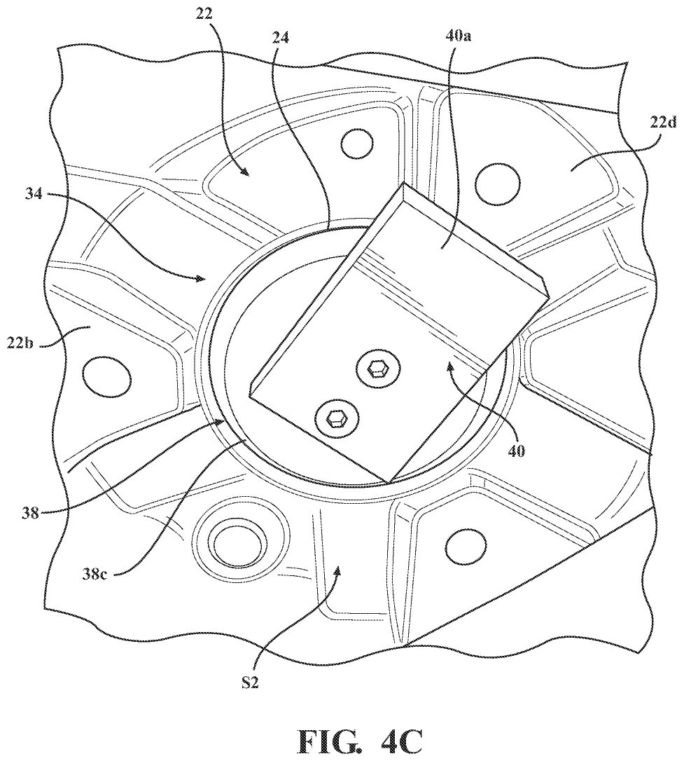

FIG. 4A is a schematic side cross-sectional view illustrating the process of engaging an anchor portion of the mounting fixture with a wheel well 22 in the engine compartment 20. FIG. 4B is the view of FIG. 4A showing the anchor portion 34 of the mounting fixture 30 fully engaged with the wheel well 22, with the anchor portion 34 secured to the wheel well. Referring to FIGS. 4A and 4B, the anchor portion 34 may be structured to secure a portion of the mounting fixture 30 to the wheel well 22. The anchor portion 34 may be attached to the base 32 along the first side S1 of the wheel well. In one or more arrangements, the anchor portion 34 may include a wheel well engagement portion 38 structured to be inserted into the opening 24 formed in the wheel well 22 along a first side S1 of the opening, to contact the wheel well 22 along an edge 24a of the opening. The wheel well engagement portion 38 may include a cylindrical edge portion 38e and a chamfered edge portion 38c extending from the cylindrical edge portion 38e. The cylindrical edge portion 38e may be structured to contact the edge 24a of the opening 24 in a close sliding fit when the cylindrical edge portion 38e is inserted into the opening 24. This structure may help prevent movement of the wheel well engagement portion 38 with respect to the wheel well 22 when the fixture 30 is mounted in the engine compartment 20 in its end-use position. The chamfered edge portion 38c may aid in centering and inserting the cylindrical edge portion 38e into the opening 24.

The anchor portion 34 further may further include a securement portion 40 attached to the wheel well engagement portion 38 and structured to bear against the wheel well 22 along a second side S2 of the opening opposite the first side S1 of the opening when the wheel well engagement portion 38 is contacting the wheel well 22 along the edge 24a of the opening 24.

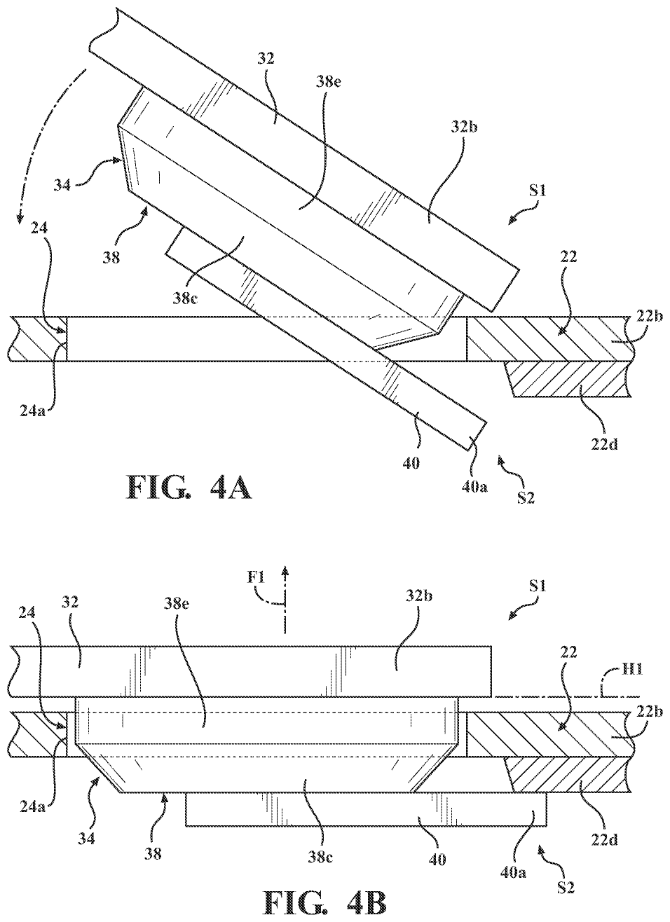

Referring to FIGS. 2 and 3, the cylinder assembly engagement member 36 may be structured and coupled to the base 32 so as to extend in a direction M1 from the base toward the cylinder assembly 28 when the fixture 30 is mounted in the engine compartment 20 in its end-use position. The cylinder assembly engagement member 36 may also be structured and coupled to the base 32 so as to form an included angle θ in the range of 90°-100° with the base 32 when the cylinder assembly engagement member 36 is coupled to the base 32.

In one or more arrangements, the cylinder assembly engagement member 36 may be structured to contact the cylinder assembly 28 to urge the cylinder assembly against the mounting surface 20f when the fixture 30 is mounted in the engine compartment 20 in its end-use position. The measure of the angle θ, the dimension D1, and other dimensions of the cylinder assembly engagement member 36 needed to secure a given cylinder assembly 28 in position for brake pedal attachment may be determined experimentally for a given arrangement of the engine compartment 20.

In particular arrangements, a spacer 42 may be attached to the cylinder assembly engagement member 36 along a side 36a thereof. Use of the spacer 42 may enable “fine tuning” of a position of the surface of the fixture 30 contacting the cylinder assembly 28, by adjusting the pertinent spacer dimension T1 instead of adjusting the dimension D1 of the cylinder assembly engagement member 36. When the desired dimension T1 is determined, the spacer 42 may be attached to the side 36a of the cylinder assembly engagement member 36 that will face the cylinder assembly 28 when the fixture 30 is mounted in the engine compartment 20 in its end-use position. The exact thickness dimension T1 of the spacer 42 needed to secure a given cylinder assembly 28 n position for brake pedal attachment may be determined experimentally for a given arrangement of the engine compartment 20.

Referring again to FIG. 4A, to engage the wheel well 22, the securement portion 40 and part of the wheel well engagement portion 38 may be inserted securement portion-first into the wheel well opening 24 from the first side S1 of the wheel well 22. an end 40a of the securement portion 40 may be positioned under a wheel well body depression 22d (or otherwise positioned along the second side S2 of the opening 24) so that when the wheel well engagement portion 38 is inserted completely into the opening 24, the securement portion 40 will abut a surface of the wheel well 22 along the second side S2 of the opening 24 (as shown in FIGS. 4B and 4C). FIG. 4C is a schematic perspective view of an underside or second side S2 of the wheel well showing the cylindrical edge portion 38e in contact with the edge 24a of the opening 24 and the securement portion 40 bearing against a depression 22d formed in the wheel well 22. The remainder of the wheel well engagement portion 38 may then be rotated and inserted into the wheel well opening 24 so that the cylindrical edge portion 38e contacts the edge 24a of the opening 24 in a close sliding fit. The anchor portion 34 is now prevented from movement out of the wheel well opening 24 in direction F1 by abutment of the securement portion 40 with the second side of the wheel well.

As the remainder of the wheel well engagement portion 38 is rotationally inserted into the wheel well opening 24 as shown in FIG. 4B, the position of the base 32 may be adjusted so as to insert the wheel well stud 26 into the base slot 32s. This may fix the base 32 rotationally with respect to the anchor portion 34, along a horizontal plane H1 extending through the anchor portion.

In particular arrangements, the dimension D1 of the cylinder assembly engagement member 36 may be selected so that it contacts the cylinder assembly 28 to hold the cylinder assembly in contact with the firewall 20f when the wheel well engagement portion 38 is mounted to the wheel well 22 and the stud 26 is received in the base slot 32s as described above. In other particular arrangements, spacer 42 may be attached to the side 36a of the cylinder assembly engagement member 36 as previously described, with the dimension T1 of the spacer 42 being selected so that the spacer 42 contacts the cylinder assembly 28 to hold the cylinder assembly in contact with the firewall 20f when the wheel well engagement portion 38 is mounted to the wheel well 22 and the stud 26 is received in the base slot 32s as described above.

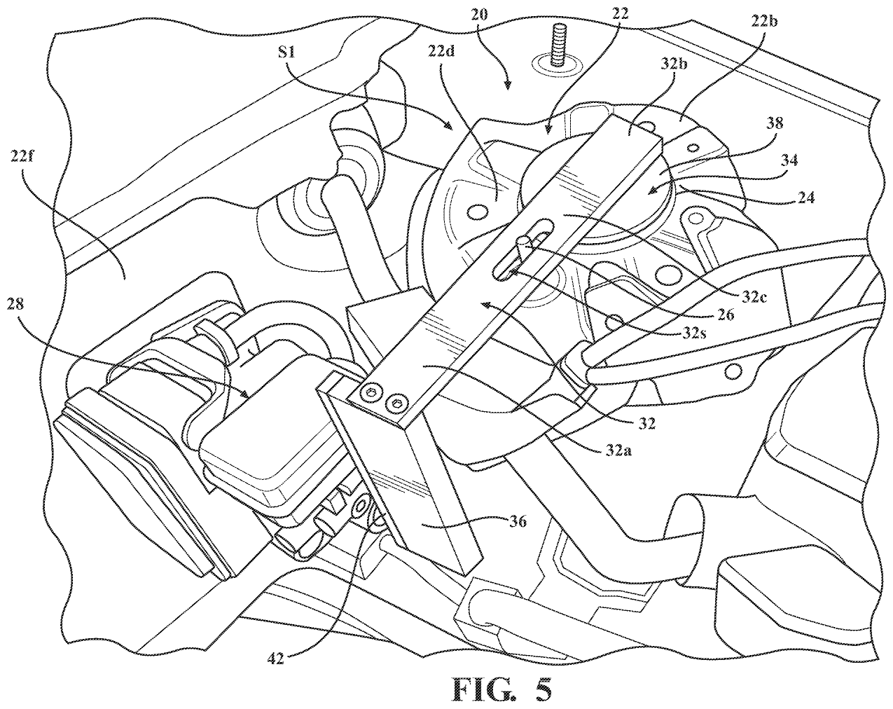

FIG. 5 is a schematic perspective view of the fixture of FIGS. 2 and 3 mounted in the vehicle engine compartment 20 and bracing the master cylinder assembly 28 against the firewall 20f.

In the above detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g. AB, AC, BC or ABC).

Aspects herein can be embodied in other forms without departing from the spirit or essential attributes thereof. Accordingly, reference should be made to the following claims, rather than to the foregoing specification, as indicating the scope of the invention.

What is claimed is:

1. A mounting fixture structured for holding a braking system master cylinder against a mounting element in a vehicle engine compartment, the fixture comprising:
a base;
an anchor portion secured to the base and structured to secure an end of the mounting fixture to a wheel well in the engine compartment; and
a cylinder assembly engagement member secured to the base opposite the anchor portion.

2. The fixture of claim 1, wherein the base has a slot positioned between the anchor portion and the cylinder assembly engagement member.

3. The fixture of claim 1, further comprising a spacer secured along a side of the cylinder assembly engagement member.

4. The fixture of claim 1, wherein the cylinder assembly engagement member is structured and coupled to the base so as to form an included angle in a range of 90°-100° with the base.

5. The fixture of claim 1, wherein the base includes a slot positioned between the anchor portion and the cylinder assembly engagement member.

6. The fixture of claim 1, wherein the anchor portion comprises a wheel well engagement portion structured to be inserted into an opening formed in the wheel well along a first side of the opening, to contact the wheel well along an edge of the opening.

7. The fixture of claim 6, wherein the anchor portion further comprises a securement portion attached to the wheel well engagement portion and structured to bear against the wheel well along a second side of the opening opposite the first side when the wheel well engagement portion is contacting the wheel well along the edge of the opening.

8. The fixture of claim 6, wherein the wheel well engagement portion comprises a cylindrical edge portion and a chamfered edge portion extending from the cylindrical edge portion.
